(19) United States
(12) Patent Application Publication
(10) Pub. No.: US 2010/0012869 A1
(43) Pub. Date: Jan. 21, 2010

(54) Dispensing arrangement for a water-dispensing appliance and water-dispensing appliance with a dispensing arrangement

(75) Inventors: Andreas Hild, Stuttgart (DE); Norbert Maier, Weissach (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 12/456,697

(22) Filed: Jun. 19, 2009

Related U.S. Application Data
(63) Continuation of application No. PCT/EP07/09822, filed on Nov. 14, 2007.

(30) Foreign Application Priority Data
Dec. 22, 2006 (DE) 10 2006 062 350

(51) Int. Cl. F16K 31/02

(52) U.S. Cl. 251/129.01; 137/605

(57) ABSTRACT

The invention relates to a dispensing arrangement for a water-dispensing appliance which is designed in particular for dispensing drinking water, having a valve device which has a valve body that can be positioned with sealing action against a valve seat, and having a dispensing body which has a first inlet and a second inlet, flow-connected to the first inlet, for the connection of water-feed lines and also has an outlet which is intended for dispensing water and is in flow connection with the first inlet and the second inlet. The flow connection between the two inlets and the outlet takes place via a channel portion which carries at an end the valve seat for the valve body, the valve seat forming a flow-deflecting element in order to change the flow direction of the water flowing from the first inlet and/or from the second inlet to the water outlet by at least 90°. The invention also relates to a water-dispensing appliance with a dispensing arrangement of this kind.

This application is a continuation of international application number PCT/EP2007/009822 filed on Nov. 14, 2007.

The present disclosure relates to the subject matter disclosed in international application number PCT/EP2007/009822 of Nov. 14, 2007 and German application number 10 2006 062 350.9 of Dec. 22, 2006, which are incorporated herein by reference in their entirety and for all purposes.

### BACKGROUND OF THE INVENTION

The invention relates to a dispensing arrangement for a water-dispensing appliance which is designed in particular for dispensing drinking water, the dispensing arrangement having a valve device which has a valve body adapted to be positioned with sealing action against a valve seat, and having a dispensing body which has a first inlet and a second inlet, flow-connected to the first inlet, for the connection of water-feed lines and also has an outlet which is intended for dispensing water and is in flow connection with the first inlet and the second inlet.

The invention also relates to a water-dispensing appliance with a dispensing arrangement via which water can be dispensed from the water-dispensing appliance.

It is an object of the present invention to provide a dispensing arrangement of the type mentioned in the introduction, at the valve seat of which improved sealing can be achieved.

### SUMMARY OF THE INVENTION

This object is achieved, according to the invention, in the case of a dispensing arrangement of the type in question, in that the flow connection between the two inlets and the outlet takes place via a channel portion which carries at a front side end the valve seat for the valve body, the valve seat forming a flow-deflecting element for changing the flow direction of the water flowing from the first inlet and/or from the second inlet to the outlet by at least 90°.

In the water which flows into the channel portion at the flow-deflecting element formed by the valve seat, the change in flow direction gives rise to turbulent vortices. On account of the vortices resulting from a change in flow direction of at least 90°, there is only a low probability of water-entrained particles being able to collect on the valve seat. If the valve seat remains largely free of particles, the valve body can engage particularly closely against the same. Improved sealing can thus be achieved at the valve seat of the dispensing arrangement according to the invention.

The dispensing body preferably comprises a basin-like region into which the channel portion projects by way of its end that forms the valve seat and which has at least one throughflow opening through which water can flow from the first inlet or from the second inlet to the outlet when the valve body is not engaging against the valve seat. Particularly good water vortices can form in the basin-like region, which is preferably round in plan view, and more preferably cylindrical. This further reduces the probability of particles collecting on the valve seat. Consequently, the latter can be sealed to even better effect by the valve body. Providing the basin-like region also has the advantage that the water can flow into the channel portion such that it is distributed uniformly over the entire circumference of the valve seat. A rotationally symmetrical flow thus forms in the region of the valve seat, and this further reduces the risk of deposits on the valve seat.

It is advantageous if the valve body is aligned coaxially in relation to the channel portion and is adapted to be displaced relative to the same, the valve body, in order to engage against the valve seat, penetrating into the basin-like region from the side which is directed away from the channel portion. For sealing the channel portion, the valve body engages against the valve seat, from which it is removed, by displacement in a direction away from the channel portion, in order to release the flow connection from the first and/or second inlet to the outlet. The valve body can be displaced in relation to the channel portion by technically straightforward means. The dispensing arrangement may thus be of straightforward design.

As already mentioned, the basin-like region may be cylindrical. It is particularly advantageous if the basin-like region is cylindrical and is oriented coaxially in relation to the channel portion.

The dispensing body preferably has a supporting surface which is disposed at the basin-like region and against which the valve device engages.

It is advantageous if the supporting surface surrounds the periphery of that end of the basin-like region which is directed away from the channel portion. The valve device can engage against the supporting surface, for example, by means of a carrier plate. The carrier plate may extend over the basin-like region and thus form a cover for the basin-like region. The carrier plate thus performs two functions. On the one hand, it supports the valve device and, on the other hand, it delimits the basin-like region. Such an embodiment of the dispensing arrangement is of straightforward design.

In an advantageous embodiment of the dispensing arrangement according to the invention, the at least one throughflow opening is formed at the end of an outflow line, at the other end of which is disposed the outlet. The water flowing through the dispensing arrangement can flow from the basin-like region through the throughflow opening, via the outflow line, to the outlet. A well-defined water-dispensing jet can be formed by means of the outflow line.

It is advantageous if the basin-like region has two or more throughflow openings, each throughflow opening being formed at the end of a line, at the other end of which is disposed an inlet for the connection of a water-feed line. This embodiment, in addition to the first inlet and the second inlet, may have further inlets, and these may be in flow connection with the outlet in each case via the basin-like region. Using this embodiment in a water-dispensing appliance thus makes it possible for a plurality of water-feed lines to be connected to the dispensing arrangement. Examples of conceivable water-feed lines here are a hot-water line, a cold-water line, a feed line for water at room temperature, a feed line for carbonated water, etc.

The valve device is preferably in the form of an electromagnetic valve and has a coil with a coil core mounted therein, this coil core forming the valve body. An electromagnetic valve is easy to actuate. When the coil is supplied with current, the coil core, which forms the valve body, can be displaced relative to the coil and to the channel portion. It can thus engage against the valve seat or be raised from the latter, in order respectively to break or release the flow connection between the first and/or the second inlet and the outlet.

The dispensing body preferably has a connecting line which connects the first inlet to the second inlet and from which the channel portion branches off. This embodiment is a straightforward design. The channel portion branching off from the connecting line can pass through, for example, a wall of a basin-like region integrally formed on the connecting line. The dispensing body may thus be of compact construction.

In a preferred embodiment, the outlet is disposed at that end of the channel portion which is directed away from the valve seat.

The dispensing body is advantageously formed in one piece. This makes it possible to keep the production costs for the dispensing body low.

The dispensing body is preferably produced from a thermally conductive material which is thermally stable at a temperature necessary for pasteurizing water. “Pasteurizing” here is understood to mean the killing off of microorganisms and bacteria located in the water by virtue of the water being heated up to a predetermined temperature for a predetermined minimum period of time. For example, the dispensing arrangement may form a subassembly of a water-dispensing appliance which can carry out a sterilizing operation, the water-channeling components of the water-dispensing appliance being flushed with hot water at a temperature of 65° C. for 15 minutes. This makes it possible to kill off microorganisms and bacteria adhering to the water-channeling components of the water-dispensing appliance. The dispensing arrangement according to the invention can be included in such a sterilizing operation by being flushed with the hot water between the first and the second inlets. The valve body is preferably disposed on the valve seat during this time. This prevents hot water from being dispensed from the water-dispensing appliance during the sterilizing operation. If the dispensing body is produced from a thermally conductive material, for example a metal such as aluminum, the hot water can deliver heat to the dispensing body. It is thus also possible for the latter to heat up in its regions which are not flushed with hot water. The regions which are not flushed can likewise be sterilized in this way.

It is advantageous if the water-channeling components of the dispensing arrangement are provided with a coating which inhibits bacterial growth. This prevents the growth of bacteria which can collect on the water-channeling components. Examples of conceivable coatings here are those with elemental silver, which have a bactericidal effect.

As mentioned in the introduction, the invention also relates to a water-dispensing appliance with a dispensing arrangement via which water can be dispensed from the water-dispensing appliance.

It is an object of the invention to provide a water-dispensing appliance, the dispensing arrangement of which has improved sealing properties.

This object is achieved according to the invention, in the case of a water-dispensing appliance of the type in question, in that the water-dispensing appliance has a dispensing arrangement of the type described above.

The following description of preferred embodiments of the invention serves for a more detailed explanation in conjunction with the drawings.

### BRIEF DESCRIPTION OF THE DRAWINGS

FIG. 1 shows a perspective view of a first embodiment of the dispensing arrangement according to the invention;

FIG. 2 shows a perspective view of a dispensing body of the dispensing arrangement from FIG. 1;

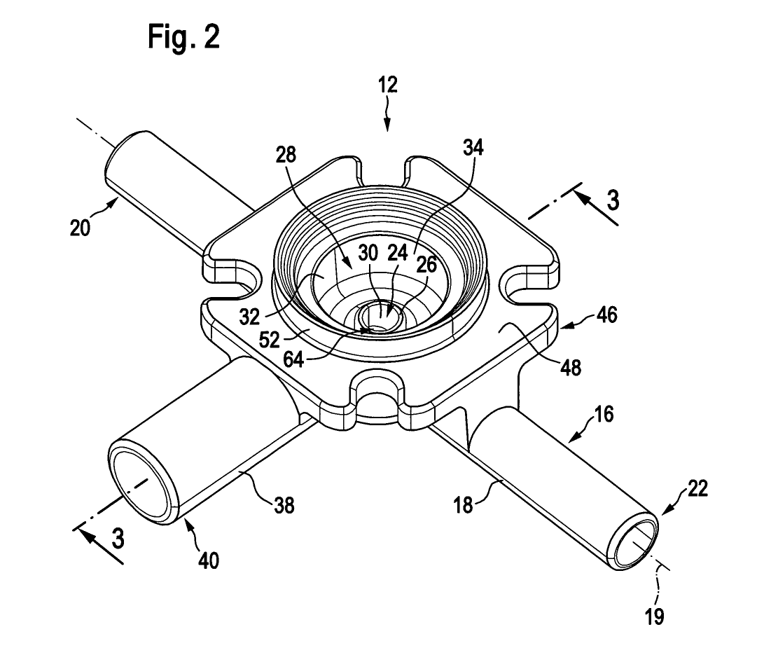

FIG. 3 shows a sectional view of the dispensing body as seen along line 3-3 in FIG. 2;

FIG. 4 shows a sectional view of the dispensing arrangement as seen along line 4-4 in FIG. 1;

FIG. 5 shows a sectional view of a second embodiment of the dispensing arrangement according to the invention; and

FIG. 6 shows a perspective view of a dispensing body of the dispensing arrangement from FIG. 5.

### DETAILED DESCRIPTION OF THE INVENTION

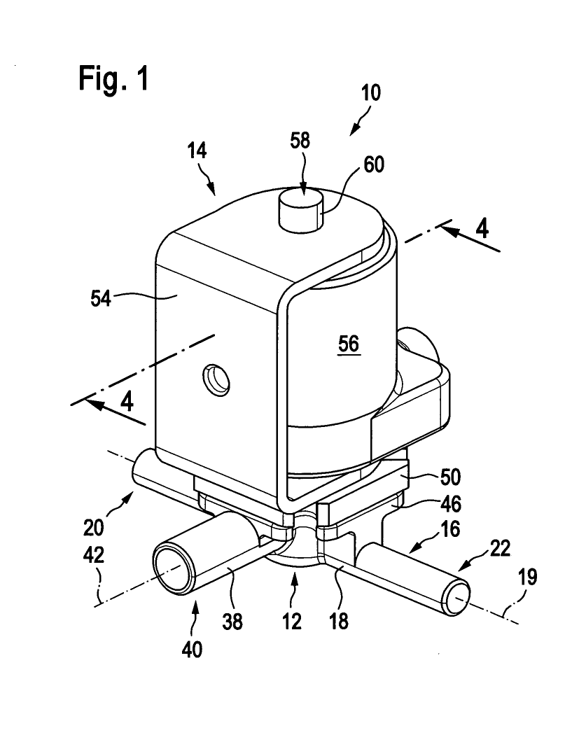

A first preferred embodiment of the dispensing arrangement according to the invention is illustrated in FIG. 1 and designated as a whole there by the reference numeral 10. The dispensing arrangement 10 forms a subassembly of a water-dispensing appliance that is designed in particular for dispensing drinking water, which can be dispensed via the dispensing arrangement 10.

The dispensing arrangement 10 has a dispensing body 12 and a valve device 14 disposed thereon. The dispensing body 12 is produced in one piece from metal, preferably from aluminum. It comprises a rectilinear flow channel 16 which forms a connecting line 18 between a first inlet 20 and a second inlet 22. Water-feed lines may be connected to the first inlet 20 and to the second inlet 22.

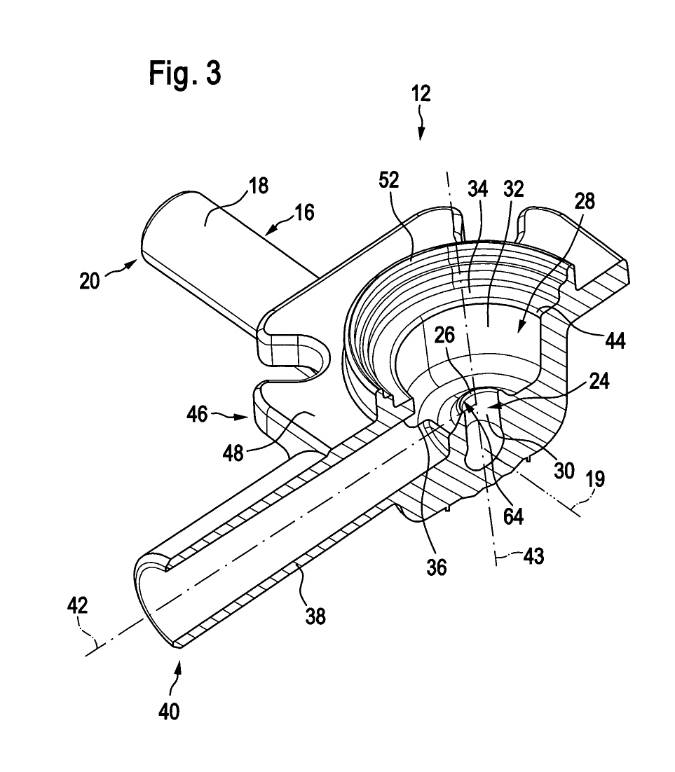

As can be seen in particular in FIG. 3, a tubular extension 24 branches from the flow channel 16 in the center between the first inlet 20 and the second inlet 22, in a radial direction in relation to the axis 19 of the flow channel 16, and the end 26 of the tubular extension, this end being directed away from the flow channel 16, passes through the wall of a basin-like region 28 of the dispensing body 12, this basin-like region being integrally formed on the flow channel 16, the end 26 projecting into the region 28. In this way, the tubular extension 24 forms, from the flow channel 16 to the end 26 of the tubular extension, a channel portion 30 via which water can flow into the basin-like region 28 from the first inlet 20 and from the second inlet 22.

The basin-like region 28 is in the form of a more or less cylindrical cup 32 and is aligned co-axially in relation to the tubular extension 24. On its side which is directed away from the end 26 of the tubular extension, the cup 32 has an opening 34 entering into the cup. Projecting radially from the cup 32, via a lateral throughflow opening 36, is an outflow line 38, at the other end of which is disposed an outlet 40 for dispensing water. The outlet 40 is in flow connection with the first inlet 20 and the second inlet 22 via the outflow line 38, the cup 32, the tubular extension 24 and the flow channel 16.

When water is dispensed through the dispensing arrangement 10, the elongate outflow line 38 gives rise to the formation of a well-defined water-dispensing jet.

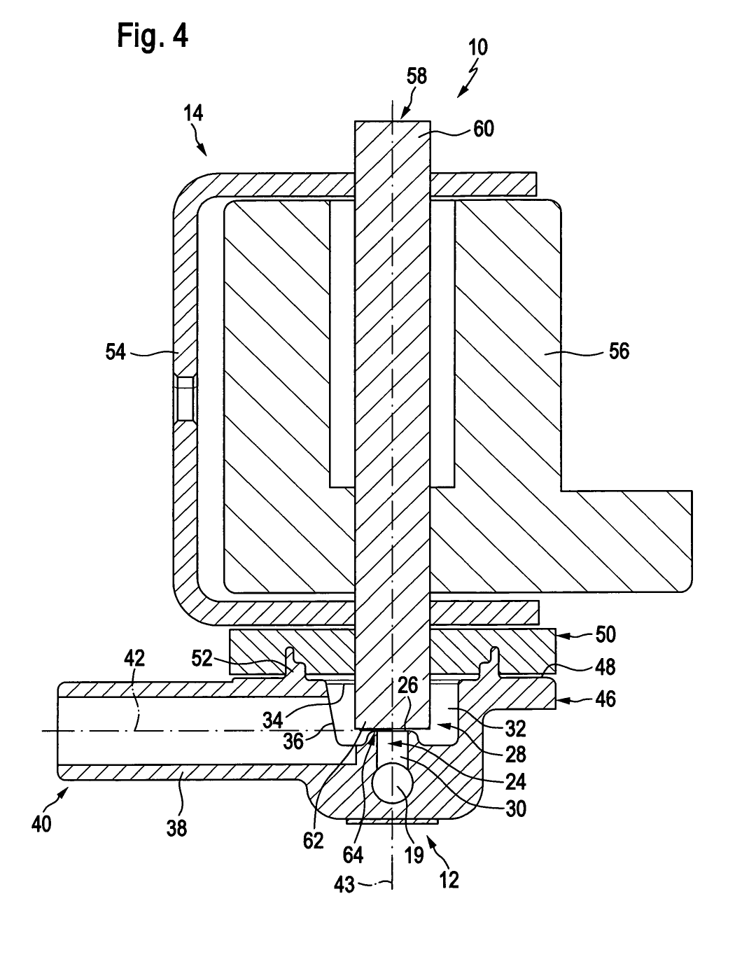

An axis 42 of the outflow line 38 is oriented perpendicularly to an axis 43 of the tubular extension 24. The end 26 of the tubular extension projects into the cup 32 to the extent where it is located opposite the center of the throughflow opening 36, through which the axis 42 of the outflow line 38 runs (FIGS. 3 and 4). In this way, the end 26 of the tubular extension forms a flow-deflecting element at which the flow direction of the water flowing from the first inlet 20 and from the second inlet 22 to the outlet 40 is changed by 90°. As a result of the change in the flow direction of the water, vortices form in the water at the end 26 of the tubular extension. As a result of the cup 32 being of round configuration in plan view, and in particular cylindrical, the water can flow in a circle at the end 26 of the tubular extension, and this promotes vortices. On account of the vortices, there is only a low probability of water-entrained particles collecting at the end 26 of the tubular extension.

Surrounding a periphery 44 of the opening 34 that enters into the cup, the dispensing body 12 has an abutting flange 46, which forms a supporting surface 48 for the valve device 14. The valve device 14 engages against the supporting surface 48 via a carrier plate 50. The carrier plate 50 forms a wall of the cup 32 in the region of the engagement opening 34. An annular collar 52, which encircles the periphery 44 and is in engagement with the carrier plate 50, ensures a good fit of the carrier plate 50 on the supporting surface 48.

The valve device 14 is electromagnetically actuable and comprises a mounting bracket 54 which is secured on the carrier plate 50 and on which is held a coil 56 in which a coil core 58 is mounted in a displaceable manner. The coil core 58 forms a valve body which is in the form of a valve pin 60 and passes through the mounting bracket 54, the carrier plate 50 and the engagement opening 34, so that it penetrates into the cup 32 from the side which is directed away from the tubular extension 24. By means of its end 62, which is directed toward the end 26 of the tubular extension, the valve pin 60 can engage against the end 26 of the tubular extension, so that the end 26 of the tubular extension forms a valve seat 64 for the valve pin 60. The valve pin 60 is aligned coaxially in relation to the tubular extension 24.

In its rest position, the valve pin 60 engages against the valve seat 64, so that the flow connection between the first inlet 20 and the outlet 40 and between the second inlet 22 and the outlet 40 is broken. The flow connection between the first inlet 20 and the second inlet 22, by way of the flow channel 16, still remains. By means of the coil 56, the valve pin 60 can be raised from the valve seat 64, and the flow connection between the first inlet 20 and the outlet 40, and between the second inlet 22 and the outlet 40, can thus be reinstated. As mentioned, on account of the vortices in the water, there is only a low probability of particles entrained by the water flowing past the valve seat 64 settling on the valve seat 64. As a result, particularly good sealing can be achieved between the valve seat 64 and the valve pin 60 when the valve pin 60 engages against the valve seat 64.

The metallic dispensing body 12 is thermally stable at a temperature which is necessary for pasteurizing water. “Pasteurizing” here is understood to mean the killing off of microorganisms and bacteria present in the water by virtue of the water being heated up to a predetermined temperature for a predetermined minimum period of time. The dispensing body 12 can be thermally sterilized by means of heated water even when the valve device is closed, i.e. when the valve pin 60 is engaging against the valve seat 64. This takes place, for example, by the flow channel 16 being flushed with hot water which is at a temperature necessary for pasteurizing the water. The hot water can deliver its heat to the dispensing body 12. The thermal conductivity of the latter means that even those regions of the dispensing body 12 which are not flushed by the water, in particular the cup 32 and the outflow line 38, are heated up. The heating operation thus makes it possible to kill off microorganisms and bacteria collected on all the water-channeling regions of the dispensing body 12. In one configuration of the dispensing arrangement 10, it has proven sufficient, for the purpose of achieving a good sterilizing result, for the flow channel 16 to be flushed with hot water at a temperature of 65° C. for 15 minutes.

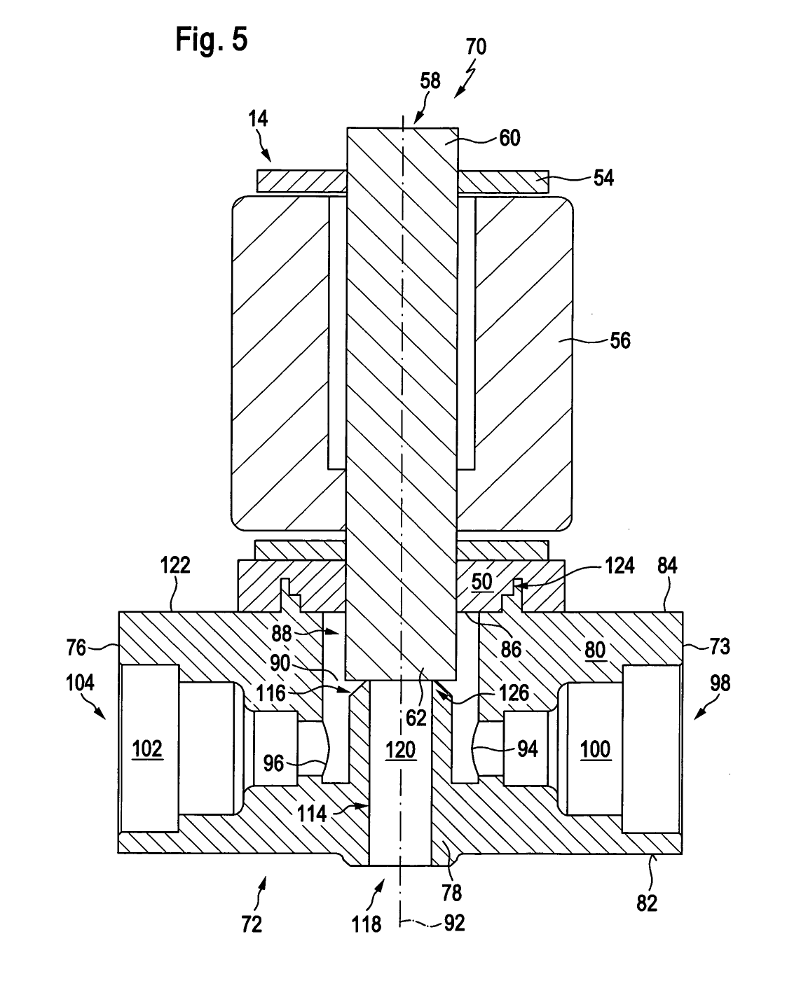

A second embodiment of a dispensing arrangement according to the invention is illustrated, and designated as a whole by the reference numeral 70, in FIG. 5. It likewise has a valve device 14 like that already explained above.

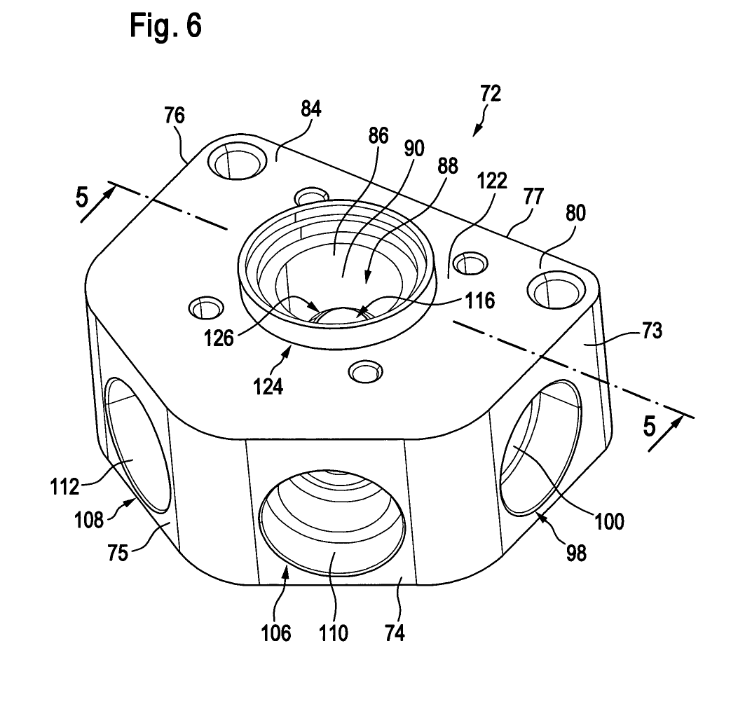

The dispensing arrangement 70 comprises a dispensing body 72, which is illustrated in perspective in FIG. 6. The dispensing body 72 is produced in one piece from metal, preferably from aluminum, and is in the form of an irregular five-sided prism, of which the side walls 73, 74, 75, 76 and 77 merge into one another in a rounded manner. The side walls 73, 74, 75, 76 and 77 connect a base wall 78 to a top wall 80, wherein the side face 82 of the dispensing body 72, this side face being formed by the base wall 78, is parallel to the side face 84 of the dispensing body 72, this side face being formed by the top wall 80. In the center of the side face 84, there is an opening 86 that enters into a basin-like region 88 formed in the dispensing body 72.

The basin-like region 88 is in the form of a cylindrical cup 90, of which the axis 92 is spaced apart equidistantly from the side walls 73, 74, 75 and 76 and is perpendicular to the side faces 82 and 84. The length of the cup 90 is approximately ⅔ of the spacing between the side faces 82 and 84. The cup 90 has four lateral throughflow openings, of which only two throughflow openings 94 and 96 can be seen in the drawing (FIG. 5).

The cup 90 is in flow connection with a first inlet 98, which is formed in the side wall 73, via the throughflow opening 94 and a flow channel 100, which widens in the direction of the side wall 73. A further flow channel 102 connects the cup 90, via the throughflow opening 96, to a second inlet 104, which is formed in the side wall 76. In the side walls 74 and 75, there are formed respectively a third inlet 106 and a fourth inlet 108, with which the cup 90 is in flow connection via respective flow channels 110 and 112, at the ends of which are disposed the two throughflow openings which are not shown. Like the flow channel 100, the flow channels 102, 110 and 112 widen in the direction of the respective side wall 76, 74 and 75. Water-feed lines can be connected to the first inlet 98, the second inlet 104, the third inlet 106 and the fourth inlet 108.

A tube portion 114 aligned co-axially in relation to the cup 90 extends from the base wall 78 in the direction of the top wall 80, so that its end 116 projects into the cup. The end 116 of the tube portion here is closer to the side face 84 than the throughflow openings 94 and 96 (and the two throughflow openings which have not been shown, and which will not be referred to again hereinbelow).

At its end which is directed away from the end 116, the tube portion 114 comprises an outlet 118 which is disposed in the center of the side face 82 and is intended for dispensing water. The cup 90 is in flow connection with the outlet 118 via the channel portion 120 defined by the tube portion 114. In this way, water can flow from the first inlet 98, from the second inlet 104, from the third inlet 106 and from the fourth inlet 108, through the cup 90, to the outlet 118.

By virtue of its arrangement relative to the throughflow openings 94 and 96, the end 116 of the tube portion forms a flow-deflecting element at which the flow direction of the flowing water is changed by 180°. This results in vortices forming in the flowing water, the cylindrical configuration of the cup 90 aiding the formation of vortices. There is therefore only a low probability of water-entrained particles settling at the end 116 of the tube portion.

The side face 84 forms a supporting surface 122 against which the valve device 14 engages by way of the carrier plate 50. The carrier plate 50 forms a wall of the cup 90 in the region of the opening 86 that enters into the cup. An annular collar 124 formed on the supporting surface is in engagement with the carrier plate 50 and ensures a good fit of the latter on the supporting surface 122.

The coil core 58 of the valve device 14, this core being in the form of a valve pin 60, is aligned co-axially in relation to the cup 90 and to the tube portion 114. It penetrates into the cup 90, passing through the mounting bracket 54, the carrier plate 50 and the engagement opening 86 in the process, so that its end 62 can engage against the end 116 of the tube portion. A valve seat 126 is thus formed at the end 116 of the tube portion. If the valve pin 60 engages against the valve seat 126, then the flow connection between the first inlet 98, the second inlet 104, the third inlet 106 and the fourth inlet 108 and the outlet 118 is broken. By means of the coil 56, the valve pin 60 can be raised from the valve seat 126, and the flow connection between the outlet 118 and the first inlet 98, the second inlet 104, the third inlet 106 and the fourth inlet 108 can thus be reinstated. As mentioned, on account of the vortices which form in the water flowing past the valve seat 126, there is only a low probability of water-entrained particles settling on the valve seat 126. Very good sealing can thus be achieved when the valve pin 60 is engaging against the valve seat 126.

The dispensing body 72, like the dispensing body 12, can be thermally sterilized by being flushed with hot water between at least two of the four inlets formed by the first inlet 98, the second inlet 104, the third inlet 106 and the fourth inlet 108. The hot water can heat up the flushed regions of the dispensing body 72, and the thermal conductivity of the latter means that the dispensing body also heats up in the regions which have not been flushed by hot water. The dispensing body 72 can thus be sterilized between the end 116 of the tube portion and the outlet 118 even when the valve device 14 is closed, i.e. when the valve pin 60 is engaging against the valve seat 126. By virtue of the tube portion 114 projecting far into the cup 90, the heat from the hot water is transferred especially well to the tube portion 114. In one configuration of the dispensing arrangement 70, it has proven sufficient, for the purpose of achieving a good sterilizing result, if the dispensing body 72 is flushed with hot water at a temperature of 65° C. for 15 minutes.

The above-described dispensing arrangements 10 and 70 may be provided, in particular in their water-channeling regions, with a coating which inhibits bacterial growth, so that the growth of bacteria which can collect in the water-channeling regions is prevented. Examples of conceivable coatings here are those which comprise elemental silver, which has a bactericidal effect.

The invention also relates to a water-dispensing appliance with a dispensing arrangement via which water can be dispensed from the water-dispensing appliance. A preferred embodiment of the water-dispensing appliance according to the invention can comprise one of the above-described dispensing arrangements 10 or 70. If the water-dispensing appliance is designed to carry out a thermal sterilizing operation by means of hot water, the dispensing arrangement 10 and/or the dispensing arrangement 70 can be thermally sterilized as described.

1. Dispensing arrangement for a water-dispensing appliance which is designed in particular for dispensing drinking water, the dispensing arrangement having a valve device which has a valve body adapted to be positioned with sealing action against a valve seat, and having a dispensing body which has a first inlet and a second inlet, flow-connected to the first inlet, for the connection of water-feed lines and also has an outlet which is intended for dispensing water and is in flow connection with the first inlet and the second inlet, wherein the flow connection between the two inlets and the outlet takes place via a channel portion which carries at a front side end the valve seat for the valve body, the valve seat forming a flow-deflecting element for changing the flow direction of the water flowing from the first inlet and/or from the second inlet to the outlet by at least 90°.

2. Dispensing arrangement according to claim 1, wherein the dispensing body has a basin-like region into which the channel portion projects by way of its end that forms the valve seat and which has at least one throughflow opening through which water can flow from the first inlet or from the second inlet to the outlet when the valve body is not engaging against the valve seat.

3. Dispensing arrangement according to claim 2, wherein the valve body is aligned coaxially in relation to the channel portion and is adapted to be displaced relative to the same, the valve body, for engagement against the valve seat, penetrating into the basin-like region from the side which is directed away from the channel portion.

4. Dispensing arrangement according to claim 2, wherein the basin-like region is cylindrical and is oriented coaxially in relation to the channel portion.

5. Dispensing arrangement according to claim 2, wherein the dispensing body has a supporting surface which is disposed at the basin-like region and against which the valve device engages.

6. Dispensing arrangement according to claim 5, wherein the supporting surface surrounds the periphery of that end of the basin-like region which is directed away from the channel portion.

7. Dispensing arrangement according to one of claim 2, wherein the at least one throughflow opening is formed at the end of an outflow line, at the other end of which is disposed the outlet.

8. Dispensing arrangement according to claim 2, wherein the basin-like region has two or more throughflow openings, each throughflow opening being formed at the end of a line at the other end of which is disposed an inlet for the connection of a water-feed line.

9. Dispensing arrangement according to claim 1, wherein the valve device is in the form of an electromagnetic valve and has a coil with a coil core mounted therein, this coil core forming the valve body.

10. Dispensing arrangement according to claim 1, wherein the dispensing body has a connecting line which connects the first inlet to the second inlet and from which the channel portion branches off.

11. Dispensing arrangement according to claim 1, wherein the outlet is disposed at that end of the channel portion which is directed away from the valve seat.

12. Dispensing arrangement according to claim 1, wherein the dispensing body is formed in one piece.

13. Dispensing arrangement according to claim 1, wherein the dispensing body is produced from a thermally conductive material which is thermally stable at a temperature necessary for pasteurizing water.

14. Dispensing arrangement according to claim 1, wherein the water-channeling components of the dispensing arrangement are provided with a coating which inhibits bacterial growth.

15. Water-dispensing appliance with a dispensing arrangement according to claim 1.
